(19) United States
(12) Patent Application Publication
(10) Pub. No.: US 2016/0267818 A1
(43) Pub. Date: Sep. 15, 2016

(54) APPARATUS AND SYSTEM FOR THE MARKING AND IDENTIFICATION OF VARIOUS MATERIALS

(71) Applicant: Kevin LINDBERG, South Salem, NY (US)

(72) Inventor: Kevin LINDBERG, South Salem, NY (US)

(21) Appl. No.: 15/069,235

(22) Filed: Mar. 14, 2016

Related U.S. Application Data
(60) Provisional application No. 62/132,035, filed on Mar. 12, 2015.

(51) Int. Cl. G09F 3/02; B65D 25/20; G09F 3/10

(52) U.S. Cl. CPC G09F 3/02; G09F 3/10; B65D 25/205; G09F 2003/0272; G09F 2003/0239

(57) ABSTRACT

Generally, the identification system can be used to identify any type of naturally occurring or manufactured good via a vertical display(s). By implementing this system, a quick and efficient identification of goods can be found in areas of disorganization or areas containing a multitude of items that are similar in size and/or appearance. The vertical displays may have removable or permanent indicia thereon that identify the particular good. The indicia may be words or images or some combination thereof. The displays may either be removably or permanently adhered to a good or may even be integrated with the good or a container holding the good therein.

### CLAIM OF PRIORITY

This application claims the priority of U.S. Ser. No. 62/132,035 filed on Mar. 12, 2015, the contents of which are fully incorporated herein by reference.

### FIELD OF THE EMBODIMENTS

The field of the invention and its embodiments relate to a system for organizing and identifying materials stored in containers, namely containers with an open/closure mechanism. In particular, the embodiments described an identification system to be used on capped or similarly situated containers to easily ascertain and identify the contents contained therein.

### BACKGROUND OF THE EMBODIMENTS

A label is a piece of material typically made from papers, polymers, metals, and the like which is affixed to a container or a product or both to identify some information as it relates to the container and/or product. Labels can display any combination of identification, general information (properties, etc.), instructions, advertising, warnings, and the like. The label or labels can be permanent or temporary depending on the intended usage and material to be adhered. Nowadays, advancements in labels have led to smart labels that contains radio frequency identification (RFID) chips and labels that are antimicrobial amongst other beneficial properties. Above all, labels can help create an organized environment.

Typically, organizational systems can be bulky and take up a lot of space that could otherwise be used for organizing especially in confined areas. Thus, it may be impractical or otherwise not useful to further limit the already abbreviated space one is attempting to organize with a bulky system. In some instances, people use many kitchen spices to elevate their cooking and to create many different types of food. Further, these spices may often be kept in varying places around the kitchen and one may forget where a particular spice has been placed. In such instances, it is beneficial to have all of these spices in one area and organized in a way that facilitates expediency when required in the kitchen.

The present invention and its embodiments meets and exceeds these objectives. Further, such embodiments may be used on virtually any good and can provide easy identification of items similar in appearance and/or size.

### Review of Related Technology:

U.S. Pat. No. 6,964,343 pertains to a container system for organizing items that makes use of wasted space in or around cabinets, for use in organizing items such as spices or items used in construction and repair. The system comprises a substantially linear holder with apertures, containers that fit into the apertures, and caps that close the containers and stop the containers from going all the way through the apertures. The holder provides removable access of containers. The containers may be labeled for easy identification and organization. The holder may have a cover with hinges and a latch. The system may be sold as a kit. The kit may be designed to match the cabinet it will be installed on. The apparatus, kit, and methods of installation and use are disclosed.

U.S. Patent Application 2012/0305177 pertains to an identi-meds system comprising a medication bottle assembly and a supplementary removeably-coupleable tag for accurately identifying contents contained in bottle(s). The medication bottle assembly includes a cap having an outer surface and an inner surface, a bottle having a body, and a prescription label. The supplementary removeably-coupleable tag includes an adhesive backing comprising an adhesive; and a peel-away sheet. The cap, the bottle, and the prescription label comprise the medication bottle assembly to contain and identify at least one medication in layman's terms. The inner surface of the cap is removably-coupleable to the body of the bottle to contain and access the medication.

European Patent Application 1353015 pertains to a device for an underground standpipe. The invention regards a covering and a marking device of a vertical standpipe mounted on a sewage pipe situated underground, the covering being designed such that it also serves as marking for the highest point of the vertical standpipe, it being the object that during carrying out mechanic excavation operations the standpipe can be more quickly localized and damage to the standpipe and the sewage system is prevented.

Various devices are known in the art. However, their structure and means of operation are substantially different from the present disclosure. The other inventions fail to solve all the problems taught by the present disclosure. At least one embodiment of this invention is presented in the drawings below and will be described in more detail herein.

### SUMMARY OF THE EMBODIMENTS

Generally, the present invention and its embodiments teach and describe a vertically situated identification system that can be used to identify any type of naturally occurring or manufactured articles and/or goods. The inventor has found that by implementing this system, a quick and efficient identification of goods can be found in areas of disorganization or containing a multitude of items. For example, being able to quickly ascertain which medicine is needed during a medical emergency without looking at every prescription label or bottle, or being able to quickly find the spice needed for cooking from a spice cabinet where all the containers are uniform in shape/size and not organized and thus not readily identifiable. Further implementations of the system will be readily apparent to those of ordinary skill in the art and may contain other uses than those explicitly described herein.

In one embodiment there is a system for the identification of goods, the system has at least one vertically situated length of material with at least two surfaces, wherein either of the at least two surfaces bears a indicia thereon, wherein the indicia is capable of being removed and/or altered; at least one vessel being coupled to the at least one vertically situated length of material, the at least one vessel having a base, a plurality of sidewalls, and a top defining a cavity therein, wherein the at least one vessel contains at least one consumer good therein, and wherein the at least one vessel comprises a material that is non-reactive with the at least one consumer good.

In another embodiment there is a system to identify an article of manufacture having at least one vertically situated, rectangular length of material having at least two surfaces, wherein either of the at least two surfaces bears a indicia thereon, wherein the indicia is capable of being removed and/or altered; at least one vessel being removably coupled to the at least one vertically situated length of material, the at least one vessel having a base, a plurality of sidewalls, and a top defining a cavity therein, wherein the at least one vessel contains at least one consumer good therein, and wherein the at least one vessel comprises a material that is non-reactive with the at least one consumer good.

In another embodiment there is an apparatus to identify an article of manufacture having a length of a tag material with two first sections and two second sections with the two second sections being coupled to one another and the two first sections being coupled to a terminal end of each of the two first sections respectively, wherein the two first sections have a top side and a bottom side, wherein the bottom side of each of the two first sections has a removable adhesive disposed thereon, wherein the two second sections have a front side and a back side, wherein the back side of each of the two second sections have a permanent adhesive disposed thereon; an indicia disposed on the front side of either or both of each of the two second sections; and wherein the back side of each second section is positioned to contact and adhere to the other and forming a substantially perpendicular structure with regard to the two first sections.

In yet another embodiment there is an apparatus to identify an article of manufacture having a circular base element with a flat base and a rounded upper surface, wherein the flat base has an adhesive structure disposed thereon, and wherein the rounded upper surface has at least one linear recess extending partially therethrough; and a length of tag material having at least a front side and a back side, wherein the length of tag material is sized to engage the at least one linear recess of the circular base element.

In general, the present invention succeeds in conferring the following, and others not mentioned, benefits and objectives.

It is an object of the present invention to provide an identification system that uses removable indicia to enable modifications to be made as necessary.

It is an object of the present invention to provide an identification system that can help organize an area of clutter without taking up undue space.

It is an object of the present invention to provide an identification system that makes similarly shaped and sized items readily identifiable.

It is an object of the present invention to provide an identification system that is inexpensive and easy to implement.

It is an object of the present invention to provide an identification system is free of moving parts.

It is an object of the present invention to provide an identification system to provide a functional service for selection of closely situated items.

It is an object of the present invention to provide an identification system that can be used in virtually any setting.

It is an object of the present invention to provide an identification system that uses any combination of words, symbols, textures, or images to identify a particular good or goods.

It is an object of the present invention to provide an identification system that is integrated with a container for a particular good.

### BRIEF DESCRIPTION OF THE DRAWINGS

FIG. 1A is a perspective view of an embodiment of the present invention demonstrating some of the structural aspects of the invention.

FIG. 1B is a perspective view of an embodiment of the present invention positioned in an intended usage.

FIG. 2 is another embodiment of the present invention.

FIG. 3 is another embodiment of the present invention.

FIG. 4 is another embodiment of the present invention.

FIG. 5 is another embodiment of the present invention.

FIG. 6 is another embodiment of the present invention.

FIG. 7 is a side view showing an embodiment of the present invention in an intended usage.

FIG. 8 is a perspective view of an embodiment of the present invention showing a manner of placement of the invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

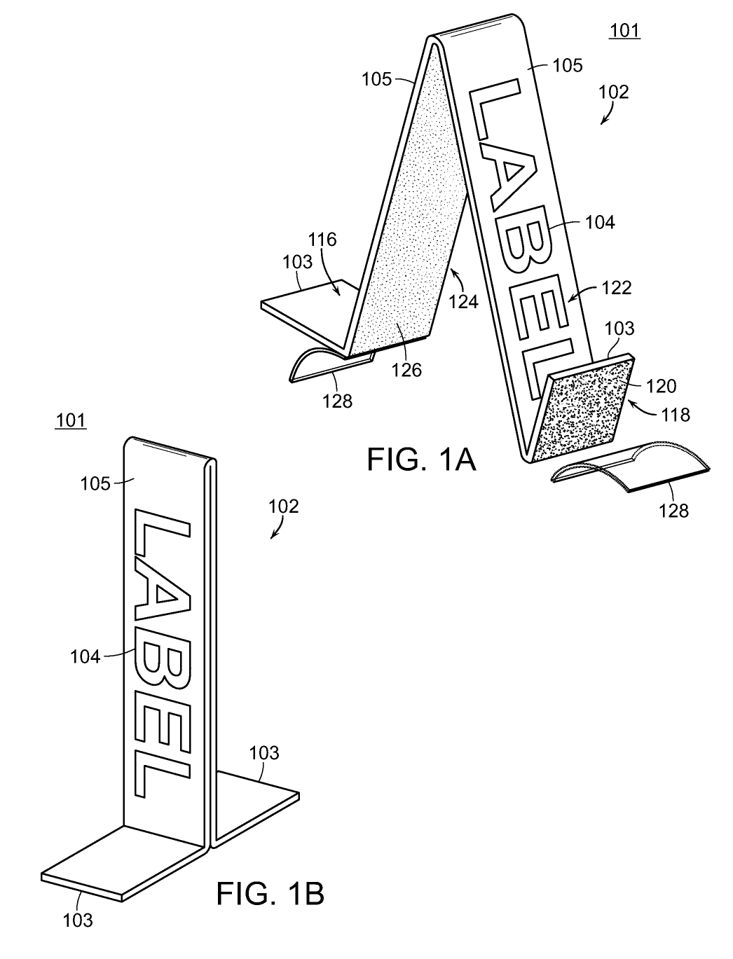

Referring now to FIGS. 1A and 1B, there is a length of material 102 in the form of an identification apparatus 101. The identification apparatus 101 can generally be used to identify any article of manufacture or consumer goods such as electronics, food items, herbs, spices, liquids, fuels, minerals, plastics, consumer products, individual people (names), and the like or any combination thereof. Virtually any item that can be identified in some fashion is included under the subject matter of the present invention and its embodiments.

In FIG. 1A, the identification apparatus 101 is shown in a “disassembled” form since the components have not yet been adhered to either each other or a secondary object such as an article of manufacture, a container, or the like. The identification apparatus 101 is generally comprised of a length of material 102. The length of material 102 may be broken down into segmented sections including two first sections 103 and two second sections 105. The number of sections may vary, but should include, in this embodiment, at least these sections. The two second sections 105 are adhered to one another along a first boundary and are independently coupled to each of the two first sections 103 on the opposing terminal end.

On a front side 122 of each of the two second sections 105 there is an indicia 104 that identifies that article to be identified by the identification apparatus 101. The indicia 104 may comprise any type of written characters, images, pictures, symbols, colors, and the like or any combination thereof. For example, a jar or container of paprika may be identified by the indicia 104 as “paprika.” Alternatively, the indicia 104 may be an image of a red pepper of which the paprika is derived. The indicia 104 may be permanent or may be capable of being altered or removed altogether and replaced as required. In some instances, the indicia 104 is on a permanent or removable substrate which is placed on the identification apparatus 101 whereas in others may reside directly on the identification apparatus 101 (i.e. written on).

On the back side 124 of the two second sections 105 there is preferably a permanent adhesive 126. The permanent adhesive 126 allows the two second sections 105 to be adhered to one another and provide a sturdy length of material for the indicia 104 to reside and be readily recognizable from most all angles. The permanent adhesive 126 may coat all or a part of the back side 124 of the two second sections 105.

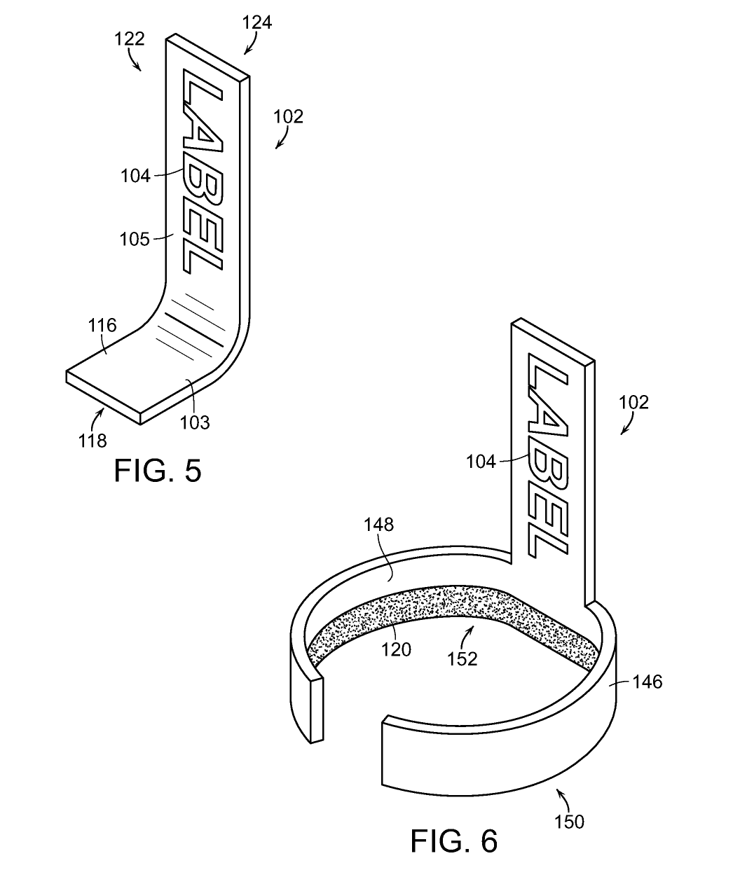

The two first sections 103 have a top side 116 and a bottom side 118. The top side 116 preferably bears no identifying indicia but may have various colors, textures, designs, and the like displayed thereon. On the bottom side 118, there is a removable adhesive 120 disposed thereon. The removable adhesive 120 enables the identification apparatus 101 to be removably placed on various containers (see FIGS. 5 & 6) as needed by a user. To prevent undesired “sticking” of the bottom side 118, removable protectors 128 may be disposed thereon. Typically, such a protection mechanism would be a “one time use” tool, but may be able to be replaced as so desired. The removable protectors 128 may be simply a thin area of coated or uncoated paper or other applicable substrate selected to be non-reactive with the removable adhesive 120 employed.

In FIG. 1B, the identification apparatus 101 is “assembled” for at least one form of intended usage. The permanent adhesive on the back of the two second sections 105 has been employed to hold these sections together. The indicia 104 is prominently displayed and facing outwards. Further, the two first sections 103 are situated to be substantially perpendicular to the two second sections 105. It is not necessary that this relationship be exactly perpendicular and may vary by up to fifteen (15) degrees in either direction respective to a ninety (90) degree perpendicular structure to satisfy this “substantial” relationship.

The size of each of the two first sections 103 and the two second sections 105 may vary and may be selected depending on the particular intended usage. For example, a group of identification apparatus 101 may be used to identify numerous similarly sized and shaped containers. Thus, the two second sections 105 may be differing heights to help distinguish this uniformity. Further, the two first sections 103 may be sized to apply a larger surface area to interact with the intended secondary object in order to provide an adequate connection between the two surfaces.

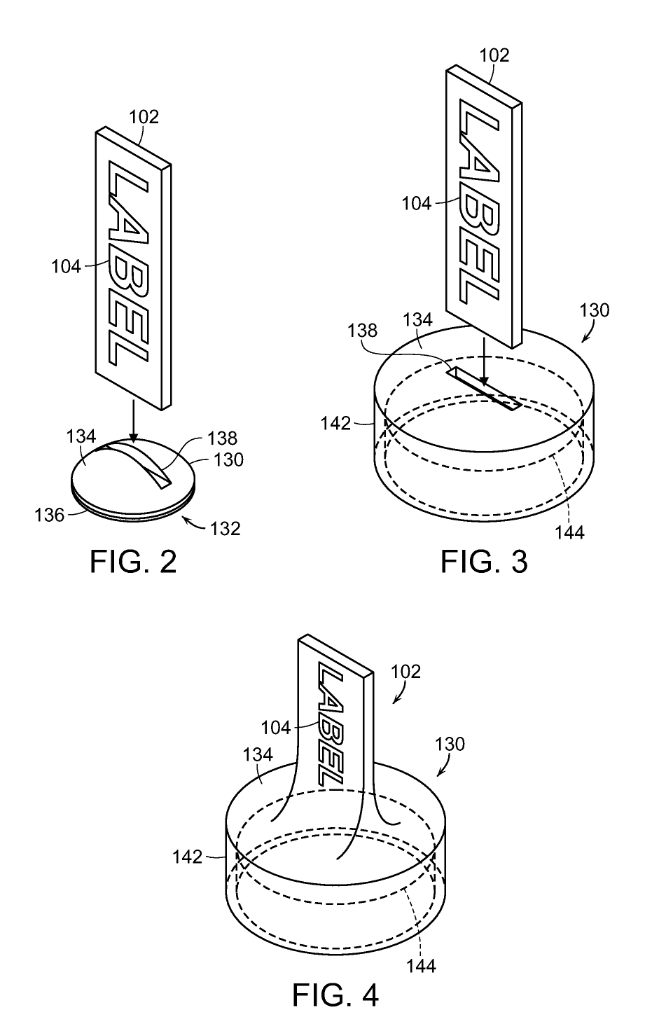

Referring now to FIG. 2, there is an embodiment of the present invention comprising generally a length of material 102 with an indicia 104 thereon. There is also a circular base element 130 which is capable of receiving the length of material 102.

The circular base element 130 may have a flat base 132 and an upper surface 134. Traversing at least a portion of the upper surface 134 is a linear recess 138. The length of material 102 may fit into the linear recess 138 and in some instances in further held therein by an adhesive residing in the recess. On the bottom or the flat base 132 there may be a coupling mechanism 136 thereon. The coupling mechanism 136 may be threading, clasps, hinges, suctioning devices, removable adhesives, and the like or any combination thereof.

In FIG. 3 there is an embodiment of the present invention that generally comprises a cap or lid 140 and a length of material 102. The length of material 102 may have an indicia 104 thereon in accordance with the previous descriptions of such an indicia 104 described herein. The cap 140 may have a coupling mechanism 144 which may be threading, a friction fitting, clasps, snaps, and the like or any combination thereof.

The cap 140 itself has an upper surface 134 and a plurality of or a singular sidewall 142. The sidewall(s) 142 are positioned downwards from the upper surface 134. The interior surface, or surface that meets the surface of the container, of the sidewalls 142 preferably bears the coupling mechanism 144 disposed thereon. Across a portion of the upper surface 134 there is a linear recess 138. The linear recess 138 is shaped to receive the length of material 102 and may contain further coupling mechanisms or adhesives to ensure the length of material 102 is coupled thereto. Preferably such a recess is linear to match the shape of the length of material 102 but may be virtually any shape, as the length of material 102 itself may be virtually any shape.

FIG. 4 describes an embodiment which is similar to that of FIG. 3, but rather has integrated the length of material 102 which the cap 140 to form a unitary structure that can be adhered to a container or other suitable object as need be. The indicia 104 is prominently displayed thereon. The cap 140 has many of the same features as described above in FIG. 3.

Referring now to FIG. 5, there is another embodiment of the present invention. In contrast to FIGS. 1A & 1B, this embodiment is formed of a length of material 102 comprising single first section 103 and a single second section 105. The two sections may be distinct sections made from the same or different materials and may also be the same material bent at a substantially perpendicular angle respect to one another. The first section has a top side 116 and a bottom side 118. The bottom side 118 preferably has a removable adhesive applied there to as previously described. The second section 105 has a front side 122 and a back side 124. The front side 122 and back side 124 each bear an indicia 104 thereon as previously described. The indicia 104 may be oriented in any direction and may be an image, characters, colors, textures, and the like or any combination thereof. The bottom side 118 of the first section 103 is intended to be adhered to the secondary item for identification.

FIG. 6 illustrates yet another embodiment of the present invention. Here there is a length of material 102 with an indicia 104 thereon. Attached to the length of material 102 is a first arm 146 and a second arm 148. The first arm 146 and second arm 148 having an outer surface 150 and an inner surface 152. The inner surface 152 preferably has a removable adhesive 120 thereon.

The first arm 146 and the second arm 148 are sized to partially or wholly envelop the circumference of a lid or cap for a container or any other item requiring a capping instrument or object that can be identified as described (i.e. capped pipe fitting, drinking vessel, etc.).

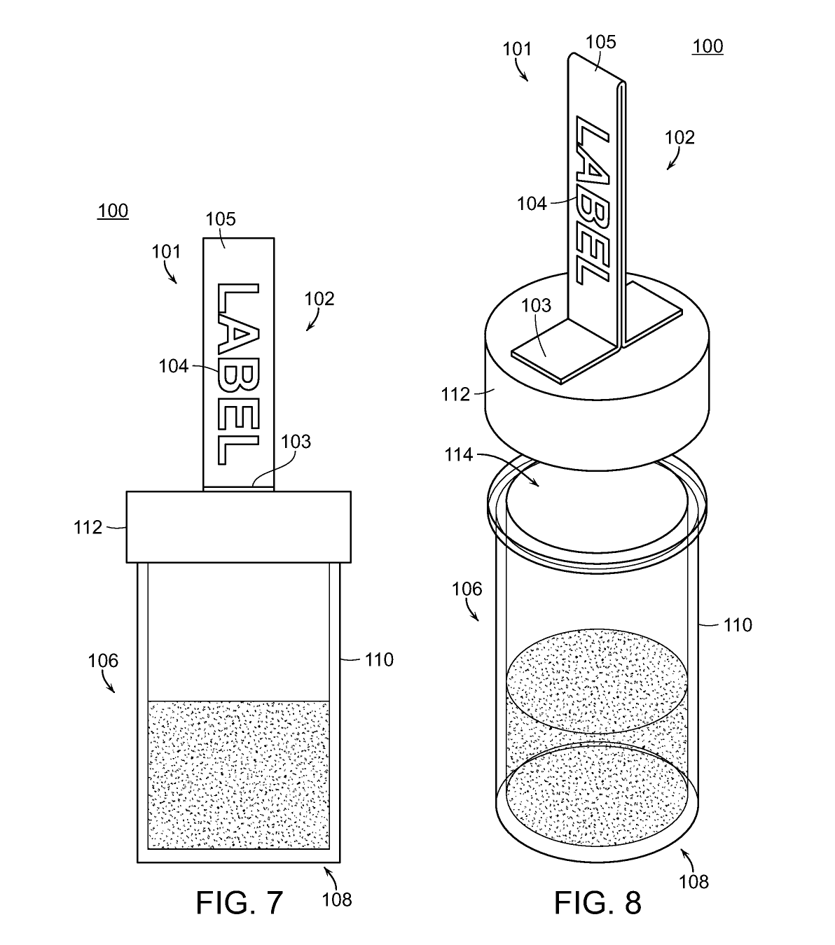

In FIGS. 7 & 8 there is one implementation of the present invention. As shown, the identification system 100 generally comprises an identification apparatus 101 and a vessel or container 106. The identification apparatus 101 shown is generally that which is described in FIGS. 1A & 1B although it may be any of the embodiments described and other variants thereof. The identification apparatus 101 has two first sections 103 and two second sections 105 with the two second sections 105 coupled to one another and the two first sections 103 coupled to a covering or top 112. The indicia 104 as described herein is shown thereon.

The vessel 106 may generally have a base 108, sidewalls 110, and a cavity 114. Preferably, any product (natural and/or synthetic), article of manufacture, and the like may be placed or stored therein. The top 112 can then be affixed thereto. It is desirable that the vessel 106 be made of generally non-reactive materials and may be selected in accordance with the material to be stored therein. For example, an acidic food item should not be stored in an aluminum, copper, or steel container which would react with the food item and impart a metallic taste to the food item.

In at least one embodiment, the present invention may prove useful is identifying spices. It is typical for spice racks or the storage of many spices in a small area to obscure the traditional labels placed on the containers. Users will then pick up individual containers looking for a specific spice, mineral, etc. In this time frame, food being prepared may burn while the user's attentiveness is turned away from the food preparation area and the food itself. Thus, the present invention and its embodiments gives a clear view of a label and raises it above the tightly held traditional labels making identification of the spices and herbs efficient and effective.

The present invention as described in FIGS. 1-8 may comprise any number and type of materials including but not limited plastics, resins, composites, and potentially some lightweight metals. Plastics may include but are not limited to polyethylene terephthalate (PET), polyethylene (PE), high-density polyethylene, polyvinyl chloride (PVC), polyvinylidene chloride (PVDC), low-density polyethylene (LDPE), polypropylene (PP), polystyrene (PS), high impact polystyrene (HIPS) and polycarbonate (PC), or any combination thereof.

Composites may include but are not limited to fiber reinforced plastics, metal composites, carbon fiber, and Kevlar® and the like. Metals may comprise lightweight metals such as aluminum and other pure metals as well as various alloys. Additionally, the present invention may comprise a combination of classes of materials such as a plastic and a textile such as woven or unwoven fabric, cloth, terrycloth, woven or non-woven fibers of wool, flax, cotton, and synthetic textiles including but not limited to nylon, polyester, and/or acrylic, or any combinations thereof. Paper products including cardboard, fiberboard, paperboard, foam board, and the like or any combination thereof. Preferably, the present invention and its embodiments are selected for their lightweight and durable properties.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A system for the identification of goods, the system comprising:
at least one vertically situated length of material having at least two surfaces,
wherein either of the at least two surfaces bears an indicia thereon,
wherein the indicia is capable of being removed and/or altered;
at least one vessel being coupled to the at least one vertically situated length of material, the at least one vessel having a base, a plurality of sidewalls, and a top defining a cavity therein,
wherein the at least one vessel contains at least one consumer good therein, and
wherein the at least one vessel comprises a material that is non-reactive with the at least one consumer good.

2. The system of claim 1 wherein the top of the at least one vessel is removable.

3. The system of claim 1 wherein the at least one vertically situated length of material is removably coupled to the top such that the at least one vertically situated length of material is substantially perpendicular to the top.

4. The system of claim 1 wherein the at least one vertically situated length of material is integrated with the top of the at least one vessel.

5. The system of claim 1 wherein there is more than one vertically situated length of material which are the same or different in height.

6. An apparatus to identify an article of manufacture comprising:
a length of a tag material having two first sections and two second sections with the two second sections being coupled to one another and the two first sections being coupled to a terminal end of each of the two first sections respectively,
wherein the two first sections have a top side and a bottom side,
wherein the bottom side of each of the two first sections has a removable adhesive disposed thereon,
wherein the two second sections have a front side and a back side,
wherein the back side of each of the two second sections have a permanent adhesive disposed thereon;
an indicia disposed on the front side of either or both of each of the two second sections; and
wherein the back side of each second section is positioned to contact and adhere to the other and forming a substantially perpendicular structure with regard to the two first sections.

7. The apparatus of claim 6 further comprising a removable protector adhered to the bottom side of each of the two first sections.

8. The apparatus of claim 6 wherein the indicia identifies a consumer good coupled to the length of tag material.

9. An apparatus to identify an article of manufacture comprising:
a circular base element having a flat base and a rounded upper surface,
wherein the flat base has an adhesive structure disposed thereon, and
wherein the rounded upper surface has at least one linear recess extending partially therethrough; and
a length of tag material having at least a front side and a back side,
wherein the length of tag material is sized to engage the at least one linear recess of the circular base element.

10. The apparatus of claim 9 wherein the circular base element is mounted on a cap or a lid of a vessel.

11. The apparatus of claim 9 wherein the adhesive structure suctions the circular base to a secondary object.

12. The apparatus of claim 9 further comprising sidewalls downwardly extending from a periphery of the circular base.

13. The apparatus of claim 12 wherein an inner surface of the sidewalls contains a securement mechanism.

14. The apparatus of claim 9 wherein the length of tag material is rectangular in shape.

15. A system to identify an article of manufacture comprising:
at least one vertically situated, rectangular length of material having at least two surfaces,
wherein either of the at least two surfaces bears a indicia thereon,
wherein the indicia is capable of being removed and/or altered;
at least one vessel being removably coupled to the at least one vertically situated length of material, the at least one vessel having a base, a plurality of sidewalls, and a top defining a cavity therein,
wherein the at least one vessel contains at least one consumer good therein, and
wherein the at least one vessel comprises a material that is non-reactive with the at least one consumer good.

16. The apparatus of claim 15 wherein the at least one consumer good is an herb, spice, or mineral, or any combination thereof.

17. The apparatus of claim 15 further comprising a recess in the top of the at least one vessel wherein,
the at least one vertically situated, rectangular length of material engages the recess.

18. The apparatus of claim 17 wherein the recess contains an adhesive disposed on a surface thereof.

19. The apparatus of claim 15 wherein the at least one vertically situated, rectangular length of material comprises a flexible polymer.
